(19) United States
(12) Patent Application Publication
(10) Pub. No.: US 2021/0389138 A1
(43) Pub. Date: Dec. 16, 2021

(54) Vehicle Communication System for Optimizing Traffic Flow

(71) Applicant: GOOGLE LLC, Mountain View, CA (US)

(72) Inventors: Mike Morton, Mountain View, CA (US); Jeremy` Faller, Mountain View, CA (US)

(21) Appl. No.: 16/901,357

(22) Filed: Jun. 15, 2020

(51) Int. Cl. G01C 21/34; G06F 16/23; G08G 1/01; G06Q 20/38; G06Q 20/32

(52) U.S. Cl. CPC G01C 21/3415; G06F 16/2365; G06Q 20/325; G06Q 20/389; G08G 1/0145

(57) ABSTRACT

To modify a route based on a user's schedule, a first device associated with a first vehicle generates a set of navigation directions for traversing from a starting location to a destination location via a first route. The first device transmits a request for a second device associated with a second vehicle to modify a second route of the second vehicle in exchange for a reward. The modified second route of the second vehicle reduces an amount of time for the first vehicle to traverse the first route to the destination location. Then the first device provides the reward to be provided to the second device in response to determining that the second vehicle performed a maneuver in accordance with the modified second route.

### FIELD OF THE DISCLOSURE

The present disclosure relates to optimizing traffic flow and, more particularly, to a vehicle communication system for transmitting and receiving requests to modify routes in exchange for rewards, such that users may arrive at destination locations at desired times.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many users request map and navigation data for various geographic locations. Software applications executing in computers, smartphones, embedded devices, etc., generate step-by-step navigation directions in response to receiving input from a user, specifying the starting point and the destination. The navigation directions are typically generated for a route which guides the user to the destination in the shortest amount of time. The amount of time for arriving at the destination may depend on the amount of traffic on the route. The navigation directions may include an indication of the amount of traffic on the route, and/or may include indications of portions of the route where there is heavy traffic.

### SUMMARY

To ensure users arrive at their destinations at desired times, a vehicle communication system obtains a first route from a starting location to a destination location for a first vehicle and/or an indication of a desired time for arriving at the destination location. The vehicle communication system may determine an estimated time of arrival at the destination location, for example based on the distance to the destination location, traffic conditions, etc. In some implementations, the vehicle communication system may obtain an intended starting time for the first vehicle to begin the first route for example from a first device associated with the first vehicle, or may determine the starting time as the current time.

In any event, when the vehicle communication system determines that the estimated time of arrival is after the desired time of arrival, the vehicle communication system may identify vehicles travelling on the same road segments as the first route, where the vehicles are likely to be in front of the first vehicle on the road segments. The vehicle communication system may then offer rewards to the vehicles for the vehicles to modify their routes to reduce the amount of time for the first vehicle to arrive at the destination location. For example, the vehicle communication system may provide requests to the vehicles to yield to the first vehicle, to change lanes from the lane occupied by the first vehicle, or to begin their routes at a later or earlier time than originally scheduled after the first vehicle passes a location of one of the vehicles. In response to the request, a second device of a second vehicle may provide an indication to the vehicle communication system that the second vehicle accepts the request, and may perform a maneuver in accordance with the request. The vehicle communication system may determine that the maneuver was performed for example, by receiving an indication from the first device that the second vehicle performed the maneuver, or receiving location data from the second device indicative of the location of the second vehicle relative to the first vehicle. Then in response to performing the maneuver in accordance with the request, the vehicle communication system may provide the reward to the second device.

In some implementations, the vehicles may be autonomous vehicles or vehicles having autonomous operation features. The first and second devices may be vehicle head units within the vehicles. In other implementations, the vehicles may be manually operated and the first and second devices may be smart phones, tablets, or other client devices within the vehicles.

Also in some implementations, the methods described herein may occur in real-time or at least near real-time such that the first device within the first vehicle offers rewards to pass or merge in front of vehicles on the same road segment as the first vehicle as the first vehicle is travelling on the road segment. The first device may provide the offers to the vehicle communication system which identifies the other vehicles on the road segment and transmits the offers to devices associated with the other vehicles. In other implementations, the first vehicle may communicate directly with other vehicles on the road segment. For example, the first vehicle may broadcast a Vehicle-to-Vehicle (V2V) wireless communication to vehicles within communication range of the first vehicle, or other short-range wireless communication such as Near Field Communication (NFC), Radio-Frequency Identification (RFID), etc. In another example, the first device associated with the first vehicle may detect identification information for the vehicles via a camera, such as a license plate number for a second vehicle, or an identifier placed on the second vehicle such as a QR code. The first device may then provide the offer to the second device associated with the second vehicle for example via a navigation application where users of the navigation application may communicate with each other. For example, each user in the navigation application may have a user profile which may be associated with a particular vehicle. The first device may then identify the user profile associated with the second vehicle and may provide the request to the user having a user profile associated with the second vehicle.

In some implementations, the first vehicle provides the reward to the vehicle communication system which holds the reward in escrow and then provides the reward to the second vehicle in response to determining that the second vehicle yielded to the first vehicle or modified the second vehicle's route in accordance with the request from the first vehicle. In other implementations, the first device associated with the first vehicle may deploy a smart contract to a distributed ledger network maintained by validating nodes. The smart contract may then act as the intermediary for the exchange of the reward to disintermediate a third-party from the process.

In particular, an example embodiment of the techniques of the present disclosure is a method for modifying a route based on a user's schedule. The method includes generating, at a first device associated with a first vehicle, a set of navigation directions for traversing from a starting location to a destination location via a route, receiving a request to modify the route in exchange for a reward, the request related to a second device associated with a second vehicle, and modifying the route in response to the request. In response to performing a maneuver in accordance with the modified route, the method includes providing an indication that the first vehicle modified the route based on the request from the second device, and receiving the reward in response to providing the indication that that the first vehicle modified the route.

Another embodiment of these techniques is a method for modifying a route based on a user's schedule. The method includes generating, at a first device associated with a first vehicle, a set of navigation directions for traversing from a starting location to a destination location via a first route, transmitting a request for a second device associated with a second vehicle to modify a second route of the second vehicle in exchange for a reward, where the modified second route of the second vehicle reduces an amount of time for the first vehicle to traverse the first route to the destination location, and providing the reward to be provided to the second device in response to determining that the second vehicle performed a maneuver in accordance with the modified second route.

Yet another embodiment of these techniques is a method for creating a smart contract for rewarding vehicles to modify routes using a distributed ledger maintained by a plurality of participants. The method includes generating a smart contract that provides a reward from a first vehicle to a second vehicle in response to the second vehicle modifying a route in a manner that benefits the first vehicle, and deploying the smart contract to an address stored on the distributed ledger maintained by the plurality of participants in a distributed ledger network, where in response to receiving an indication that the second vehicle performed a maneuver in accordance with the modified route, the smart contract provides the reward to a device associated with the second vehicle.

### BRIEF DESCRIPTION OF THE DRAWINGS

FIG. 1 illustrates a block diagram of an example communication system in which techniques for optimizing traffic flow can be implemented;

FIG. 2 illustrates an example vehicle in which the techniques of the present disclosure can be used to transmit and receive requests to modify routes in exchange for rewards;

FIG. 3 illustrates an example navigation display indicating a route from a starting location to a destination location and including a user control to request to pass or merge in front of other vehicles along the route;

FIG. 4 illustrates an example yield request display including user controls for the user to select a particular vehicle to pass or merge in front of and an indication of the reward provided in exchange for passing or merging in front of the particular vehicle;

FIG. 5 illustrates an example yield request received display indicating a request from another user on the route to pass or merge in front of the vehicle and indicating the position of the other user's vehicle relative to the user;

FIG. 6 illustrates an example yield request smart contract state in a distributed ledger network;

FIG. 7 illustrates an exemplary transaction representing an evidence transaction generated by a vehicle reporting that the vehicle yielded to the requestor;

FIG. 8 is a flow diagram of an example method for modifying a route based on a user's schedule, which may be implemented in a client device providing a yield request; and

FIG. 9 is a flow diagram of an example method for modifying a route based on a user's schedule, which may be implemented in a client device receiving the yield request.

### DETAILED DESCRIPTION

### Overview

Many people have busy schedules where they are expected to arrive at various locations at predetermined times. However, due to unforeseen circumstances such as traffic, weather conditions, or previous engagements taking longer than expected, people may find themselves running late to their scheduled destinations. At the same time, many others on the road may not have specific times in which they have to arrive at their destinations or may be scheduled to arrive early. Accordingly, users of the vehicle communication system described herein who are in a hurry or running late may request other users who are not in a hurry to yield to them or modify their respectively routes, so that the users in a hurry may arrive at their destinations on time.

Furthermore, the users who do not have specific times in which they have to arrive at their destinations or who are scheduled to arrive early at their destinations may try to time their trip so that they arrive at their destinations as a podcast, video, song, sporting event, radio show, or other audio/video presentation comes to an end. To do so, the communication system may receive requests from and cause the user's vehicle to yield to enough other vehicles to prolong the trip, such that the user arrives at the destination as the audio/video presentation comes to an end.

Users may provide requests prior to beginning their respective routes. For example, a user planning on going to the airport the next day may determine that she needs to arrive at the airport at 10:00 a.m. However, due to prior obligations she may be unable to leave her house before 9:30 a.m. Based on expected traffic conditions, she may determine, via a navigation application, that her expected time of arrival is 10:05 a.m. To ensure she arrives at the airport on time, she may provide requests via the vehicle communication system to other vehicles scheduled to be on the road at the same time as the user. In exchange for a reward, the other vehicles may agree to begin their routes later or to let her pass or merge in front of them on the road so that she may arrive at the airport on time. For example, she may provide requests to vehicles having deadlines for arriving at their respective destination locations which are more than a threshold amount of time after estimated times of arrival at the respective destination locations.

Additionally, users may provide requests in real-time or at least near real-time as the users are travelling on their respective routes. For example, a user may be on his route to work when he realizes based on the current traffic conditions that he is unlikely to arrive at his office on time. The user may then provide requests via the vehicle communication system to other vehicles currently ahead of the user on the user's route to let the user pass or merge in front of the other vehicles so that the user may arrive at work on time.

Generally speaking, the techniques for transmitting and receiving requests to modify routes in exchange for rewards can be implemented in one or several client devices, one or several head units of vehicles such as an autonomous vehicle or a vehicle having one or more autonomous operation features, one or several network servers, one or several validating nodes in a distributed ledger network, or a system that includes a combination of these devices. However, for clarity, the examples below focus primarily on an embodiment in which a navigation application executes on a client device within a vehicle to transmit and receive requests from other client devices/vehicles to modify their respective routes in exchange for a reward.

More specifically, the navigation application may generate a set of navigation directions for navigating along a route from a starting location to a destination location. The navigation application may also determine an estimated amount of time for arriving at the destination location and may include an estimated time of arrival at the destination location. In some implementations, the navigation application may generate the set of navigation directions and determine the estimated time of arrival by communicating with a navigation server.

Additionally, the navigation application may identify vehicles on the route currently located ahead of the vehicle associated with the navigation application. The navigation application may include user controls for the user to request one or several of the identified vehicles to yield to the vehicle in exchange for a reward. In this manner, the vehicle may pass or merge in front of the other vehicles on the route to arrive at the destination earlier than expected. The navigation application may identify the other vehicles on the route by communicating with a traffic flow server or by obtaining identification information for the other vehicles via sensors or a communication link.

The navigation application may include user controls for selecting the amount and/or type of reward for yielding to the vehicle. Additionally or alternatively, the navigation application may automatically determine the amount and/or type of reward which may be a default reward for yielding to the vehicle. The navigation application may then transmit the request to a selected vehicle which may accept the request. The request may be transmitted via the traffic flow server or may be transmitted directly to the selected vehicle via a V2V communication protocol.

In any event, in response to receiving an indication that the request has been accepted, the user may transmit the reward to the traffic flow server which may hold the reward in escrow until the request is completed. Then, the selected vehicle may complete the request by performing a maneuver in accordance with the request, such as moving into another lane or performing any other suitable action to allow the vehicle to pass or merge in front of the selected vehicle. The selected vehicle and/or the navigation application may transmit an indication that the request has been completed to the traffic flow server. For example, the navigation application may verify that the request has been completed upon passing or merging in front of the selected vehicle. In another example, the navigation application may transmit an indication of the current location of the vehicle, and the selected vehicle may transmit an indication of its current location to the traffic flow server, and the traffic flow server may determine that the vehicle passed or merged in front of the selected vehicle based on their respective locations. In any event, the traffic flow server may then provide the reward to the selected vehicle.

In other implementations, instead of using the traffic flow server as an intermediary for the exchange, the navigation application may generate and deploy a smart contract to a distributed ledger network maintained by validating nodes. The smart contract may indicate the terms of the exchange, including the amount of the reward and the requested maneuver for the selected vehicle. The user may transmit the reward to a smart contract address on the distributed ledger network for the smart contract and the smart contract may release the reward to the selected vehicle in response to determining that the selected vehicle completed the request. For example, the navigation application may provide an indication that the request has been completed to the smart contract, or the selected vehicle may provide an indication of its current location to the smart contract to verify that the request has been completed.

### Example Hardware and Software Components

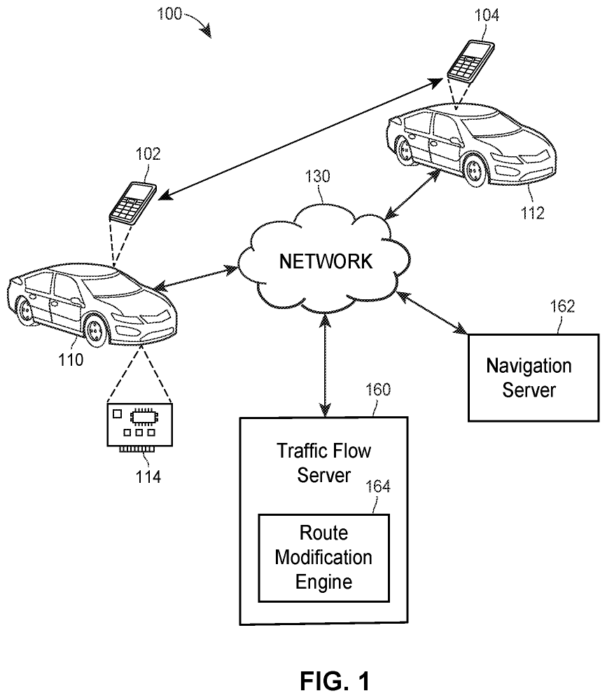

Referring to FIG. 1, an example communication system 100 in which a vehicle communication system can be implemented includes client computing device 102, 104 (also referred to herein as a “client device”) configured to execute a geographic applications, which also can be referred to as “navigation application.” Depending on the implementation, the navigation application can display an interactive digital map, request and receive routing data to provide driving, walking, or other navigation directions, provide various geolocated content, etc. The client device 102, 104 may be operated by a user displaying a digital map while navigating to various locations. Furthermore, the client device 102, 104 may be operated within a vehicle 110, 112. The vehicles 110, 112 may include vehicles 110, 112 having autonomous operation features, as well as vehicles that do not have autonomous operation features. As illustrated, the vehicle 110 may include a vehicle controller, which may be a vehicle head unit 114 as discussed elsewhere herein. Each of vehicles 110, 112 may be configured for wireless inter-vehicle communication, such as vehicle-to-vehicle (V2V) wireless communication and/or data transmission via a communication component, directly via the client devices 102, 104, or otherwise.

Each of the client devices 102, 104 may be configured to send data to and/or receive data from one another and/or via network 130 using one or more suitable communication protocols, which may be the same communication protocols or different communication protocols. For example, client devices 102, 104 may be configured to communicate with one another via a direct radio link, which may utilize, for example, a Wi-Fi direct protocol, an ad-hoc cellular communication protocol, etc. Client devices 102, 104 may also be configured to communicate with vehicles 110, 112, respectively (e.g., via their respective vehicle head units 114), utilizing a Bluetooth® communication protocol.

To provide additional examples, client devices 102, 104 may be configured to communicate with one another via radio links by each communicating with network 130 utilizing a cellular communication protocol. As an additional example, client devices 102, 104 may be configured to communicate with remote server devices, such as traffic flow server 160 and a navigation server 162, via radio links. Similarly, the vehicle head units 114 may be configured to communicate directly to the network 130 or indirectly through respective client devices 102, 104. Vehicles 110 may also communicate with other vehicle 112 and/or client devices 104 directly or indirectly through the client device 102 in communication range of the vehicle 110. As discussed elsewhere herein, network 130 may be implemented as a wireless telephony network (e.g., GSM, CDMA, LTE, etc.), a Wi-Fi network (e.g., via one or more IEEE 802.11 Standards), a WiMAX network, a Bluetooth network, etc. Thus, links may represent wired links, wireless links, or any suitable combination thereof. For example, the links may include wired links to the network 130, in addition to, or instead of, wireless radio connections.

In addition to the client devices 102, 104 and the vehicles 110, 112, the communication system 100 includes a traffic flow server 160 configured to provide navigation directions for navigating on a route from a starting location to a destination location to a client device 102, receive a request for other vehicles 112 along the route to yield to the vehicle 110 associated with the client device 102, communicate with the other vehicles 112 along the route to identity a vehicle 112 that accepts the yield request, obtain and hold the reward from the client device 102 in escrow, and/or provide the reward to the vehicle 112 that accepts the yield request upon completion of the yield request. The traffic flow server 160 can be communicatively coupled to a database that stores, in an example implementation, location information for other vehicles 112, navigation directions for current or scheduled routes for the other vehicles 112, reward information for the other vehicles 112 indicating previous reward types and/or reward amounts accepted by users associated with the other vehicles 112, etc.

More generally, the traffic flow server 160 can communicate with one or several databases that store any type of suitable geospatial information or information. The communication system 100 also can include a navigation data server 162 that provides driving, walking, biking, or public transit directions, for example for presentation via the navigation application. Further, the communication system 100 can include a map data server that provides map data to the client device 102 for generating a map display.

The map data server and navigation server 162 may be coupled to a map database which includes schematic and satellite data storing street and road information, topographic data, satellite imagery, etc. The navigation server 162 is also coupled to a traffic database which includes current traffic conditions and/or estimated future traffic conditions, and also may include road closure data, estimated time data, etc. Furthermore, the navigation server 162 may be coupled to a weather database which includes current weather data and/or estimated future weather data in various geographic areas. In general, the navigation server 162 can receive information related to geographic locations from any number of suitable databases, web services, etc.

Depending on the implementation, the navigation server 162 can provide map and directions data to client devices separately or together in map tiles, for example. In other embodiments, the map data and navigation directions may be generated remotely on remote servers separate from the map data server and navigation server 162. Moreover, in some embodiments, the map and navigation directions may be generated by a combination of the map data server, the navigation server 162, and any number of additional servers.

In some implementations, the traffic flow server 160 receives map and directions data from the map data server and/or the navigation server 162 including a route for navigating from the starting location to the destination location. The traffic flow server 160 may provide the route to the client device 102 and receive a yield request from the client device 102. The traffic flow server 160 may then compare the route for the client device 102 to routes of other vehicles 112 to identify vehicles 112 for providing the yield request. In other implementations, the traffic flow server 160 communicates directly with the map database, the traffic database, and/or the weather database to generate a route from the starting location to the destination location and provide the route to the client device 102 for navigating to the destination location.

The client device 102, 104 may be a portable device such as smart phone or a tablet computer, for example. The client device 102, 104 may also be a laptop computer, a desktop computer, a personal digital assistant (PDA), a wearable device such as a smart watch or smart glasses, etc. The client device 102, 104 also can communicate with various content providers, servers, etc. via a wired or wireless communication network 130 such as a fourth- or third-generation cellular network (4G or 3G, respectively). The client device 102, 104 may include a memory, one or more processors (CPUs), a graphics processing unit (GPU), a network interface unit, an I/O module, a user interface (UI) for displaying map data and directions, and a global positioning system (GPS) or another suitable positioning module. The memory can be a non-transitory memory and can include one or several suitable memory modules, such as random access memory (RAM), read-only memory (ROM), flash memory, other types of persistent memory, etc. The I/O module may be a touch screen, for example. In various implementations, the client device 102, 104 can include fewer components or conversely, additional components.

The memory stores an operating system (OS), which can be any type of suitable mobile or general-purpose operating system. The memory also stores a navigation application which is configured to generate interactive digital maps and/or perform other geographic functions, as indicated above. The navigation application can receive map data in a raster (e.g., bitmap) or non-raster (e.g., vector graphics) format from the map data server and present the map data. In some cases, the map data can be organized into layers, such as a basic layer depicting roads, streets, natural formations, etc., a traffic layer depicting current traffic conditions, a weather layer depicting current weather conditions, a navigation layer depicting a path to reach a destination, etc. The navigation application also can display driving, walking, or transit directions, and in general provide functions related to geography, geolocation, navigation, etc.

The navigation application is configured to transmit a request for navigation directions from a starting location to a destination location, receive a set of navigation directions for navigating along a route to the destination location, and present the set of navigation directions on the user interface. The navigation application is also configured to transmit and receive yield requests. The navigation application may identify vehicles 112 on the route ahead of the vehicle 110 associated with the client device 102. In some implementations, the navigation application may identify the vehicles 112 by for example, broadcasting a V2V wireless communication to vehicles 112 within communication range of the vehicle 110 or by detecting identification information for the vehicles 112 using vehicle sensors or sensors within the client device 102. The identification information may be detected via a camera, and may include a license plate number or an identifier placed on the vehicle 112 such as a QR code. In other implementations, the navigation application may identify the vehicles 112 by communicating with the traffic flow server 160.

In any event, in response to identifying vehicles 112 on the route ahead of the vehicle 110, the navigation application may transmit yield requests to the one or several of the identified vehicles 112. The yield requests may include a reward type (e.g., cryptocurrency, fiat currency, rewards points, etc.) and/or a reward amount (e.g., $5) which may be determined automatically or may be selected by a user via user controls at the navigation application. The reward type and/or reward amount may be a default reward type and/or reward amount, or may be determined based on previous rewards. More specifically, the reward type and/or reward amount may be determined based on previous rewards provided within the same geographic area as the yield request, based on previous rewards for the same type of yield request, etc.

The navigation application is also configured to receive an indication of acceptance of the yield request and identification information of the vehicle 112 accepting the yield request. Furthermore, in some implementations, the navigation application is configured to provide the reward to the traffic flow server 160, which is then provided to the vehicle 112 accepting the yield request upon completion of the yield request. In other implementations, the navigation application is configured to generate and deploy a smart contract to a distributed ledger network which includes the terms of the exchange, including the amount of the reward and the requested maneuver for the vehicle 112.

The navigation application is also configured to receive yield requests from other vehicles 112 and/or client devices 104. The navigation application may include user controls for the user to accept the yield request and receive the corresponding reward. Furthermore, the navigation application may communicate with the vehicle head unit 114, for example when the vehicle 110 is an autonomous vehicle, to cause the vehicle 110 to complete the yield request by performing a maneuver in accordance with the yield request, such as changing lanes or slowing down to allow the requesting vehicle 112 to pass or merge in front of the vehicle 110. Additionally, the navigation application may transmit an indication to the traffic flow server 160, a smart contract, and/or the requesting vehicle 112 that the yield request has been completed. The indication may include a current location of the vehicle 110 where the navigation application is operating.

It is noted that although the navigation application is described as a standalone application, the functionality of the navigation application also can be provided in the form of an online service accessible via a web browser executing on the client device 102, as a plug-in or extension for another software application executing on the client device 102, etc. The navigation application generally can be provided in different versions for different respective operating systems. For example, the maker of the client device 102 can provide a Software Development Kit (SDK) including the navigation application for the Android™ platform, another SDK for the iOS™ platform, etc. Furthermore, in addition to executing on the client device 102, the navigation application may execute on the vehicle head unit 114 of the vehicle 110, 112, for example when the vehicle 110, 112 is an autonomous vehicle.

In some implementations, the traffic flow server 160 includes one or more processors and a memory. The memory may be tangible, non-transitory memory and may include any types of suitable memory modules, including random access memory (RAM), read-only memory (ROM), flash memory, other types of persistent memory, etc. The memory stores instructions executable on the processors that make up a route modification engine 164, which can generate a route for navigating from a starting location to a destination location. The route modification engine 164 can also receive yield requests from vehicles 110, 112 and/or client devices 102, 104, identify vehicles 110, 112 ahead of the requestor on the requestor's route or scheduled to be ahead of the requestor on the requestor's scheduled route, and provide the yield requests to the identified vehicles 110, 112. The route modification engine 164 may receive indications of acceptance of the yield requests from the identified vehicles 110, 112 and may provide the reward to the vehicles 110, 112 accepting the yield requests in response to determining that the vehicles 110, 112 completed the yield request.

The route modification engine 164 and the navigation application 14 can operate as components of a vehicle communication system. Alternatively, the vehicle communication system can include only server-side components and simply provide the navigation application with instructions to display the set(s) of navigation directions for traveling from the starting location to the destination location along the route(s) and process the yield requests. In other words, vehicle communication techniques in these embodiments can be implemented transparently to the navigation application. As another alternative, the entire functionality of the route modification engine 164 can be implemented in the navigation application.

For simplicity, FIG. 1 illustrates the traffic flow server 160 as only one instance of a server. However, the traffic flow server 160 according to some implementations includes a group of one or more server devices, each equipped with one or more processors and capable of operating independently of the other server devices. Server devices operating in such a group can process requests from the client device 102, 104 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

Furthermore, although the communication system 100 includes one network 130, two client devices 102, 104, two vehicles 110, 112, and two remote server devices 160, 162, various embodiments of the communication system 100 may include any suitable number of networks 130, client devices 102, 104, vehicles 110, 112, and/or remote server devices 160, 162.

In operation, the navigation application operating in the client device 102, 104 or the vehicle head unit 114 receives and transmits data to the traffic flow server 160. Thus, in one example, the client device 102, 104 or the vehicle head unit 114 may transmit a communication to the route modification engine 164 (implemented in the traffic flow server 160) requesting navigation directions from a starting location to a destination location.

Accordingly, the route modification engine 164 may identify a route for navigating from the starting location to the destination location, and may transmit a set of navigation directions for the identified route to the client device 102, 104 or the vehicle head unit 114. The route modification engine 164 may also transmit an indication of the estimated time period for traversing the route. For example, the route modification engine 164 may obtain a route and estimated time period for traversing the route from the navigation server 162, from the map database, and/or from the traffic database.

The navigation application may receive a request to reduce the time period for traversing the route, for example via user controls or automatically based on a scheduled time for arriving at the destination location. The navigation application may then obtain identification information for vehicles 112 ahead of the vehicle 110 on the route by communicating with the vehicles 112 via a V2V wireless communication with vehicles 112 within communication range of the vehicle 110 or by using vehicle sensors or sensors within the client device 102. The identification information may be detected via a camera, and may include a license plate number or an identifier placed on the vehicle 112 such as a QR code. In other implementations, the navigation application may identify the vehicles 112 by communicating with the traffic flow server 160. In some implementations, in response to identifying the vehicles 112, the navigation application may transmit the identification information for the vehicles 112 to the traffic flow server 160 which may transmit contact information for communicating with the identified vehicles 112 to the navigation application. For example, each navigation application may include a user profile with a user ID and identification information for a vehicle where the navigation application operates. The traffic flow server 160 may provide the user ID for the user profile associated with the identified vehicle 112 to the navigation application for the navigation application to communicate the yield request to the identified vehicle.

In some implementations, the route modification engine 164 may obtain indications of deadlines for arriving at destination locations from vehicles and/or client devices within the vehicles. The route modification engine 164 may then provide identification information to the navigation application for vehicles having deadlines for arriving at their respective destination locations which are more than a threshold amount of time after estimated times of arrival at the respective destination locations.

In any event, the navigation application may transmit the yield request including a reward amount, a reward type, and/or a description of the type of request (e.g., pull over, slow down, switch lanes, begin the route at a later or earlier time, etc.) directly to the identified vehicle 112, client device 104 associated with the identified vehicle 112, or via the traffic flow server 160 (e.g., by transmitting the request to the user profile associated with the obtained user ID). The navigation application may obtain the reward amount and/or reward type via user controls at the navigation application. In other implementations, the route modification engine 164 may generate a recommended reward amount and/or reward type based on previous yield requests in the same geographic area as the yield request, for the same type of yield request, and/or for the same identified vehicle 112. The route modification engine 164 may provide the recommended reward amount and/or reward type to the navigation application.

Accordingly, the route modification engine 164 may transmit the yield request to the identified vehicle 112 and may receive an acceptance or rejection of the request from the identified vehicle 112. The route modification engine 164 may then forward the acceptance or rejection of the request to the navigation application. When the identified vehicle 112 accepts the request, the route modification engine 164 may request the navigation application to provide the reward to the route modification engine 164 to hold the reward in escrow, or may request the navigation application to generate and deploy a smart contract and transmit the reward to the smart contract. The navigation application may then provide the reward to the traffic flow server 160 by for example transmitting the reward to a financial account for the traffic flow server 160 for example, via a financial service, such as Venmo®, PayPal®, etc., or by providing financial information to the traffic flow server 160, such as a credit card number. In another example, the navigation application may provide the reward to the traffic flow server 160 by transmitting a cryptocurrency via a distributed ledger to a distributed ledger address for the traffic flow server 160. In yet another example, the navigation application may provide rewards points to the traffic flow server 160.

In any event, the traffic flow server 160 may then provide the reward to the identified vehicle 112 in response to determining that the identified vehicle 112 completed the yield request. The traffic flow server 160 may transmit the reward to a financial account for the identified vehicle 112 for example, via a financial service, such as Venmo®, PayPal®, etc. In another example, the traffic flow server 160 may provide the reward to the identified vehicle 112 by transmitting a cryptocurrency via a distributed ledger to a distributed ledger address for the identified vehicle 112. In yet another example, the traffic flow server 160 may provide rewards points to the identified vehicle 112.

The traffic flow server 160 may determine that the identified vehicle 112 completed the yield request in response to receiving an indication for the requestor vehicle 110 that the identified vehicle 112 completed the request. Additionally or alternatively, the traffic flow server 160 may obtain location information for the requestor vehicle 110 and/or the identified vehicle, and may determine that the identified vehicle 112 completed the yield request based on the respective locations of the vehicles 110, 112.

In other implementations, the navigation application may provide the reward directly to the identified vehicle 112 and/or the client device 104 associated with the identified vehicle 112 by for example transmitting the reward to a financial account for the identified vehicle 112 and/or the client device 104 associated with the identified vehicle 112 via a financial service, such as Venmo®, PayPal®, etc. In another example, the navigation application may provide the reward to the identified vehicle 112 and/or the client device 104 associated with the identified vehicle 112 by transmitting a cryptocurrency via a distributed ledger to a distributed ledger address for the identified vehicle 112 and/or the client device 104 associated with the identified vehicle 112. In yet another example, the navigation application may provide rewards points to the identified vehicle 112 and/or the client device 104 associated with the identified vehicle 112. The navigation application may also include a review or rating component for rating vehicles or users who do not make payments. Vehicles or users having ratings below a threshold rating may not be able to use the vehicle communication system or other vehicles or users may be presented with the reviews and ratings so that they may not accept yield requests from vehicles with low ratings.

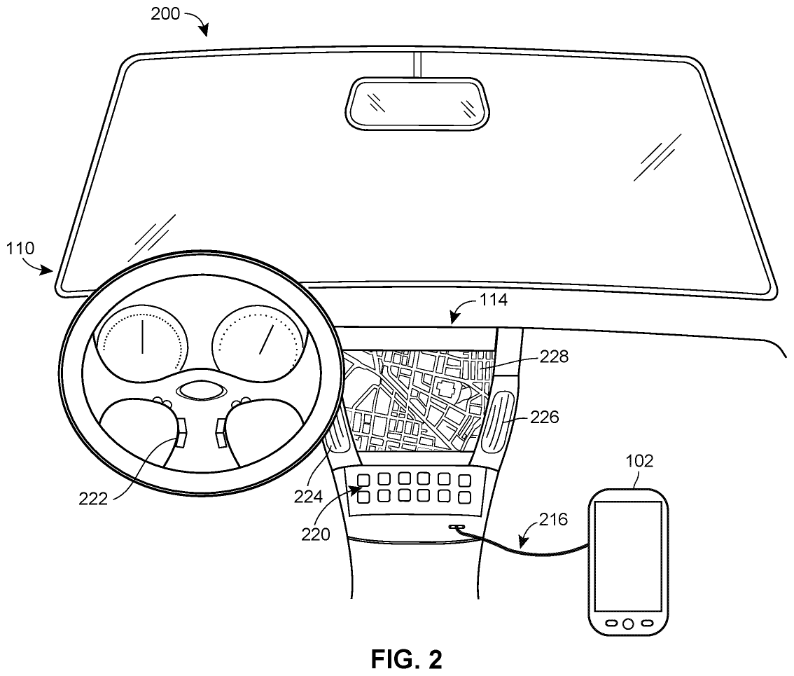

FIG. 2 illustrates an example vehicle environment 200 which includes a client device 102 and a vehicle 110 with a head unit 114. The client device 102 communicates with the head unit 114 of the vehicle 110 via a communication link 216, which may be wired (e.g., Universal Serial Bus (USB)) or wireless (e.g., Bluetooth, Wi-Fi Direct). The client device 102 also can communicate with various content providers, servers, etc. via a wireless communication network such as a fourth- or third-generation cellular network (4G or 3G, respectively).

The head unit 114 can include a display 218 such as a digital map, which may present the set of navigation directions to the destination location, and/or indications of vehicles 112 for providing yield requests. The display 218 in some implementations is a touchscreen and includes a software keyboard for entering text input, which may include the name or address of a destination, point of origin, etc. Hardware input controls 220 and 222 on the head unit 114 and the steering wheel, respectively, can be used for entering alphanumeric characters or to perform other functions for requesting navigation directions. The head unit 114 also can include audio input and output components such as a microphone 224 and speakers 226, for example. The speakers 226 can be used to play the audio instructions sent from the client device 102.

As described above, the navigation application operating on the client device 102, 104 or the vehicle head unit 114 of a vehicle 110, 112, may present user controls for transmitting and receiving yield requests. In other implementations, such as when the vehicle 110, 112 is an autonomous vehicle, the vehicle head unit 114 may automatically determine when to transmit yield requests, such as when the estimated time of arrival at a destination location is after a scheduled time for the user or the vehicle 110, 112 to arrive at the destination location. For example, the vehicle head unit 114 may obtain calendar data from the user's electronic calendar to determine the scheduled time for the user to arrive at the destination location.

In some implementations, in addition to transmitting yield requests when the estimated time of arrival at a destination location is after a scheduled time for the user or the vehicle 110, 112 to arrive at the destination location, the navigation application may adjust a scheduled departure time from the user's starting location. In some scenarios, the navigation application may communicate with other applications on the user's client device 102 to for example, adjust an alarm clock to wake the user up earlier or later which may cause the user to leave from the starting location earlier or later.

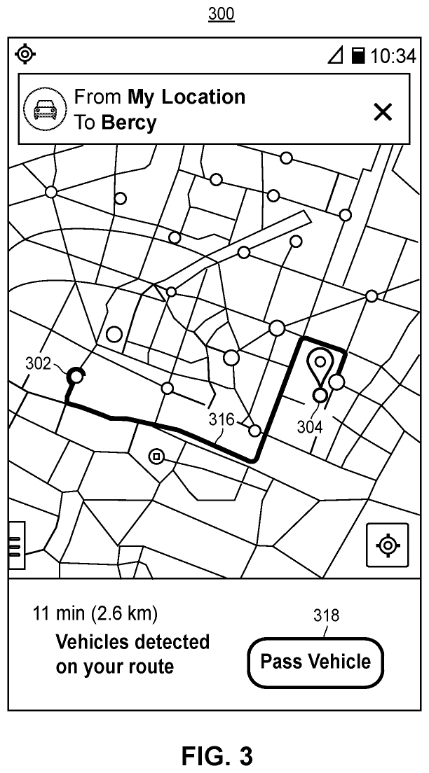

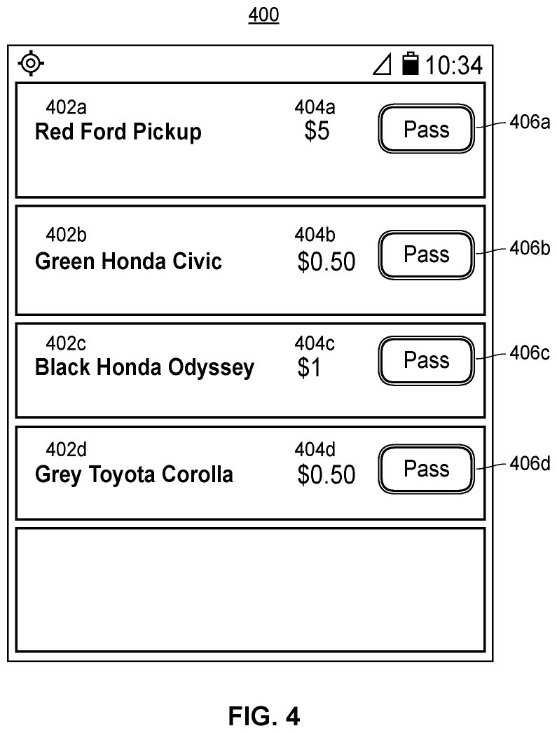

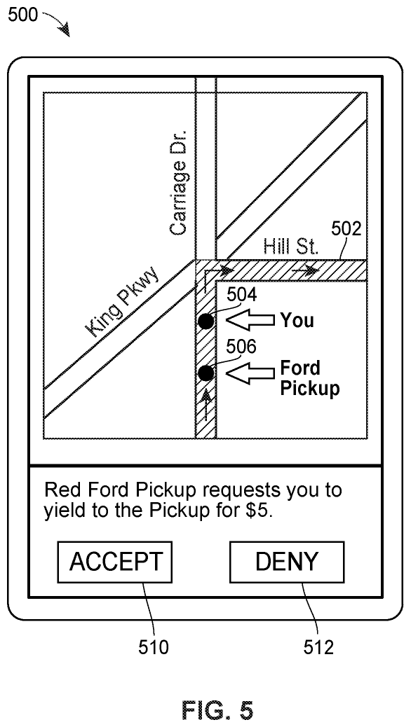

In any event, FIGS. 3-5 illustrate example displays which may be presented on the client device 102, 104. More specifically, FIGS. 3 and 4 illustrate example displays which may be presented on the requesting client device 102, while FIG. 5 illustrates an example display which may be presented on the client device 104 receiving the yield request. The example navigation display 300 as shown in FIG. 3 includes an indication of a route 316 from a starting location 302 to a destination location 304. Additionally, the example navigation display 300 includes a user control 318 for selecting vehicles for providing yield requests.

In some scenarios, when the user begins the route 316, the navigation application may identify other vehicles 112 along the route 316 which are ahead of the user's vehicle 110. For example, the navigation application may identify the other vehicles 112 by communicating with the vehicles 112 via a V2V wireless communication with vehicles 112 within communication range of the vehicle 110. The navigation application may also identify the vehicles 112 using vehicle sensors or sensors within the client device 102. The identification information may be detected via a camera, and may include a license plate number or an identifier placed on the vehicle 112 such as a QR code. In another example, the navigation application may identify the vehicles 112 by communicating with the traffic flow server 160. More specifically, the traffic flow server 160 may receive location information for several vehicles 112 via their respective navigation applications, and may identify vehicles 112 having locations which are within a threshold distance of the user's vehicle 110 and which are ahead of the user's vehicle 110 on the route 316. In any event, the navigation application may present the user control 318 on the navigation display 300 or the user control 318 may become selectable in response to identifying other vehicles 112 along the route 316 which are ahead of the user's vehicle 110.

In other scenarios, before the user begins the user 316, the navigation application may identify other vehicles 112 which are scheduled to be ahead of the user's vehicle 110 along the route 316 and/or are scheduled to be within a threshold distance of the user's vehicle 110. More specifically, the navigation application may communicate with the traffic flow server 160, which may obtain scheduled routes for other vehicles 112 within the same geographic area as the route 316. The traffic flow server 160 may identify vehicles 112 scheduled to be ahead of the user's vehicle 110 along the route 316 and/or scheduled to be within a threshold distance of the user's vehicle 110 based on the scheduled routes. The traffic flow server 160 may then provide identification information for the identified vehicles 112 to the navigation application. Then the navigation application may present the user control 318 on the navigation display 300 or the user control 318 may become selectable in response to identifying other vehicles 112 which are scheduled to be ahead of the user's vehicle 110 along the route 316 and/or are scheduled to be within a threshold distance of the user's vehicle 110.

In response to receiving a selection of the user control 318 for selecting vehicles for providing yield requests, the navigation application may present a yield request display including user controls for the user to select a particular vehicle 112 to pass or merge in front of. FIG. 4 illustrates an example yield request display 400 which may be presented on the requesting client device 102. The yield request display 400 includes indications 402a-402d of identified vehicles 112 for the user to provide yield requests. The yield requests may include real-time or near real-time yield requests for the vehicles 112 to yield to the user's vehicle 110 on their current routes. Additionally, the yield requests may include future yield requests for the vehicles 112 to yield to the user's vehicle 110 on scheduled routes or for the vehicles 112 to begin their scheduled routes at a later or earlier time or alter their scheduled routes.

For each identified vehicle 402a-402d, the yield request display 400 may include a reward type and/or reward amount 404a-404d, and may include user controls for manually adjusting the reward type and/or reward amount 404a-404d. The reward types and/or reward amounts 404a-404d may be default reward types and/or reward amounts and may be the same for each of the identified vehicles 402a-402d. Additionally or alternatively, the reward types and/or reward amounts 404a-404d may be recommended reward types and/or reward amounts automatically determined for each identified vehicle 402a-402d based on several factors, such as the type of yield request for the identified vehicle 402a (e.g., pull over, slow down, switch lanes, begin the route at a later or earlier time, etc.), and previous yield requests in the same geographic area as the yield request, for the same type of yield request, and/or for the same identified vehicle 402a.

In some implementations, the yield request display 400 may include the type of yield request for each identified vehicle 402a-402d, and/or user controls for manually adjusting the type of yield request. Additionally, for each identified vehicle 402a-402d, the yield request display 400 may include a user control 406a-406d for selecting the vehicle 402a-402d to transmit a yield request. The user may select multiple vehicles and may transmit multiple yield requests or may select a single vehicle and transmit a single yield request.

In response to receiving a selection of one or several of the user controls 406a-406d, the navigation application may transmit the yield request to the selected vehicle(s) 402a-402d. For example, the navigation application may transmit an indication of the selected vehicle(s) 402a-402d, the type of yield request, the type of reward, and/or the reward amount to the traffic flow server 160 which may forward the yield request to the selected vehicle(s) 402a-402d. In other implementations, the navigation application may transmit the yield request directly to the selected vehicle(s) 402a-402d, such as via a V2V wireless communication.

In any event, the selected vehicle(s) 402a-402d may receive the yield request at a respective navigation application(s) within a vehicle head unit(s) 114 or at a client device(s) 104 communicatively coupled to the selected vehicle(s) 402a-402d. The navigation application may then present a yield request received display indicating a request from another user on the route to pass or merge in front of the selected vehicle 112 and indicating the position of the other user's vehicle 110 relative to the user's vehicle 112.

FIG. 5 illustrates an example yield request received display 500 which may be presented on the client device 104 receiving the yield request. For example, the user of the client device 104 receiving the yield request may not have a specific time in which she has to arrive at her destination and may be trying to time her trip so that she arrives at her destinations as a podcast, video, song, sporting event, radio show, or other audio/video presentation comes to an end. The user may select a user control within the navigation application indicating a particular time in which she prefers to arrive at the destination. The user may also select a user control indicating a particular audio/video presentation which she prefers to end before arriving at the destination, and the navigation application may determine the scheduled time in which the particular audio/video presentation ends. Additionally or alternatively, the user may not select a user control, and the navigation system may automatically determine that the user prefers to arrive at the destination after the end of the particular audio/video presentation based on the user's previous habits or based on an indication from the user that the user has a preference to finish audio/video presentations before exiting the vehicle. Also in some implementations, the navigation application may vary the speed of the audio/video presentation (e.g., by invoking an application programming interface (API) for the application presenting the audio/video presentation) to fast forward or skip over certain portions to ensure that the audio/video presentation ends before arriving at the destination.

In any event, the example yield request received display 500 includes an indication of the route 502 for the client device 104 receiving the yield request. The example yield request received display 500 also includes indications of the respective current locations 504, 506 of the requestee/yielder vehicle 112 and the requestor/yieldee vehicle 110. As shown in FIG. 5, the requestee/yielder vehicle 112 is slightly ahead of the requestor/yieldee vehicle 110 and both vehicles are heading northbound on Carriage Drive. Additionally, the example yield request received display 500 includes a description of the yield request 508, including a description of the requestor vehicle 110 (a Red Ford Pickup) and the reward type/reward amount ($5). The description may also include the type of yield request, such as change lanes, pull over, slow down, turn, etc. Moreover, the example yield request received display 500 includes user controls 510, 512 for the user to accept 510 or deny 512 the yield request. In response to receiving a selection of the user control 512 to deny the yield request, the navigation application may present a navigation display similar to the navigation display 300 shown in FIG. 3. The navigation application may also transmit a response to the yield request to the requestor/yieldee vehicle 110 indicating that the request is denied. In response to receiving a selection of the user control 510 to accept the yield request, the navigation application may transmit a response to the yield request to the requestor/yieldee vehicle 110 indicating that the request is accepted. If the requestee/yielder vehicle 112 is operated manually, the driver may perform a maneuver in accordance with the yield request. If the requestee/yielder vehicle 112 is an autonomous vehicle, the navigation application may provide control signals to cause the requestee/yielder vehicle 112 to perform a maneuver in accordance with the yield request. The navigation application may then transmit an indication that the yield request has been completed to the traffic flow server 160 and/or the requestor/yieldee vehicle 110. The indication may include a current location of the requestee/yielder vehicle 112. In response to verifying that the yield request has been completed the traffic flow server 160 may transmit the reward to the requestee/yielder vehicle 112 and/or client device 104.

As described above, to exchange the reward from the requestor/yieldee vehicle 110 to the requestee/yielder vehicle 112, the traffic flow server 160 may act as an intermediary holding the reward in escrow until the traffic flow server 160 verifies that the request has been completed by the requestee/yielder vehicle 112. In other implementations, the requestor/yieldee vehicle 110 may generate and deploy a smart contract to a distributed ledger network maintained by validating nodes. The smart contract may indicate the terms of the exchange, including the amount of the reward and the requested maneuver for the requestee/yielder vehicle 112. The user may transmit the reward to a smart contract address on the distributed ledger network for the smart contract and the smart contract may release the reward to the requestee/yielder vehicle 112 in response to determining that the requestee/yielder vehicle 112 completed the request.

A distributed ledger is a storage mechanism for data, events, transactions, etc. that is maintained by several participants. More specifically, a distributed ledger is a way of achieving a distributed consensus on the validity or invalidity of information recorded in the distributed ledger. In other words, the distributed ledger provides a decentralized trust to participants and observers. As opposed to relying on a central authority, a distributed ledger is a decentralized database in which a transactional record of changes to the ledger is maintained and validated by each node of a peer-to-peer network. One type of distributed ledger, a blockchain, is comprised of groupings of transactions organized together into a “block,” and ordered sequentially (thus the term “blockchain”). While the distributed ledgers discussed herein are referred to in the context of a blockchain, this is merely one example of a distributed ledger. Distributed ledgers may also include a tangle, a block lattice, or other directed acyclic graph (DAG). In any event, nodes may join and leave the blockchain network over time and may obtain blocks from peer nodes that were propagated while the node was gone. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network. The nodes in the distributed ledger network validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. A consensus rule may require that blocks and transactions adhere to format requirements and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules are propagated from nodes that have validated the addition to other nodes that the validating node is aware of. If all of the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule is disregarded by validating nodes that receive the change and the change is not propagated to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable.

The validation activities of nodes applying consensus rules on a blockchain network may take various forms. In one implementation, the blockchain may be viewed as a shared spreadsheet that tracks data such as the ownership of assets. In another implementation, the validating nodes execute code contained in “smart contracts” and distributed consensus is expressed as the network nodes agreeing on the output of the executed code.

A smart contract is a computer protocol that enables the automatic execution and/or enforcement of an agreement between different parties. In particular, the smart contract may be computer code that is located at a particular address on the blockchain. In some cases the smart contract may run automatically in response to a participant in the blockchain sending funds (e.g., a cryptocurrency such as bitcoin, ether, or other digital/virtual currency) to the address where the smart contract is stored. Additionally, smart contracts may maintain a balance of the amount of funds that are stored at their address. In some scenarios when this balance reaches zero the smart contract may no longer be operational.

The smart contract may include one or more trigger conditions, that, when satisfied, correspond to one or more actions. For some smart contracts, the action(s) performed may be determined based upon one or more decision conditions. In some instances, data streams may be routed to the smart contract so that the smart contract may detect that a trigger condition has occurred and/or analyze a decision condition.

Blockchains may be deployed in a public, decentralized, and permissionless manner meaning that any party may view the distributed ledger, submit new information to be added to the ledger, or join the network as a validating node. Other blockchains are private (e.g., permissioned ledgers) that keep chain data private among a group of entities authorized to participate in the blockchain network. Other blockchain implementations may be both permissioned and permissionless whereby participants may need to be validated, but only the information that participants in the network wish to be public is made public.

By utilizing smart contracts in the vehicle communication system, the system may provide a trusted, secure, and immutable record of yield requests, vehicles/devices accepting the yield requests, and evidence of the yield requests being completed. In this manner, the vehicle communication system may disintermediate a third-party from the process of exchanging the reward.

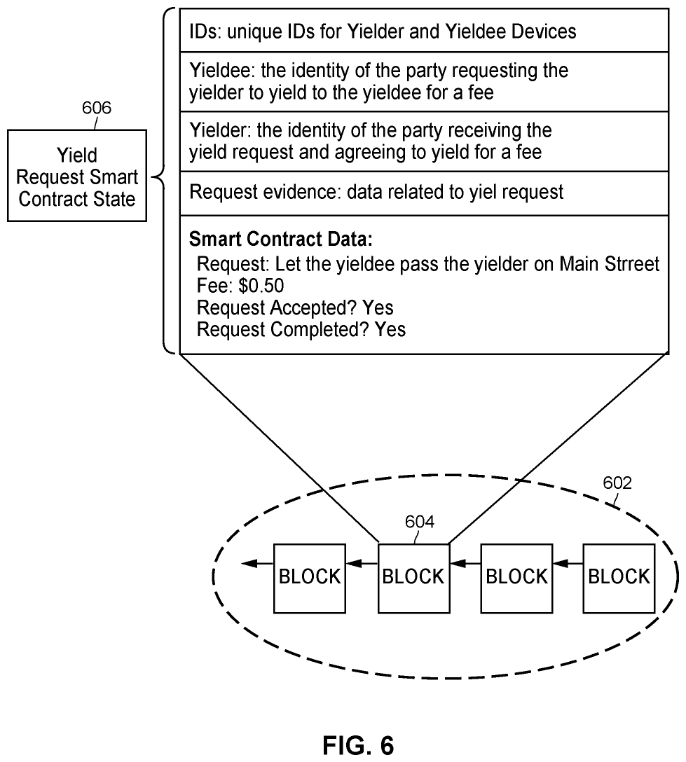

FIG. 6 depicts an exemplary smart contract state 606 for a smart contract deployed by a requestor vehicle 110 or requestor client device 102 in a distributed ledger network. FIG. 6 includes a blockchain 602, a block of transactions 604, and a yield request smart contract state 606. A smart contract may be deployed by any participant in the distributed ledger network or blockchain network to establish a contract state 606 for a yield request, for example. The deployed smart contract may expose methods and data to other participants in the blockchain network, such as other vehicles/client devices in the same geographic area as the requestor vehicle 110 or requestor client device 102. Some of the data in the smart contract state may be private data that may only be altered by calling a method of the smart contract, or only altered by authorized blockchain participants. One way of altering the smart contract state is to broadcast a transaction to the distributed ledger network. If the broadcasted transaction satisfies consensus rules, network validators may include the transaction in a block. Inclusion in the blockchain of a transaction sending data to the smart contract may cause validating nodes to update a state database for the smart contract, thus allowing network participants access to a rich state mechanism to manage the yield request, and ultimately to provide the reward to the requestee/yielder vehicle 112/client device 104.

The yield request smart contract state 606 may include pieces of data to identify the vehicle 110 or client device 102 submitting the yield request (also referred to herein as the “yieldee”) and/or the vehicle 112 or client device 104 receiving the yield request (also referred to herein as the “yielder”). In some embodiments, the yieldee may be identified by cryptographic public keys assigned to the yieldee's electronic wallet. The yielder may also be identified by cryptographic public keys assigned to the yielder's electronic wallet.

In some embodiments, a contract owner may select a unique ID for the yield request such that subsequent transactions and data sent to the smart contract can identify the yield request by ID number. The contract owner may also specify identifiers of yielders authorized to complete the yield request. In one example, the yieldee may deploy a smart contract to the distributed ledger after receiving an indication from a yielder that the yielder accepts the yield request. In this example, the yielder may be specified as authorized to complete the yield request. In another example, the yieldee may identify vehicles ahead of the yieldee on the route and may deploy a smart contract to the distributed ledger prior to receiving any indications from the vehicles that the vehicles accept the yield request. Instead, the yieldee may specify identifiers of each of the identified vehicles as authorized to complete the yield request. Then when the smart contract is deployed to the distributed ledger network, each of the identified vehicles may complete the yield request and receive a reward. In yet another example, the yieldee may deploy a smart contract to the distributed ledger prior to receiving any indications from the vehicles that the vehicles accept the yield request. Instead, the smart contract may include a current location of the yieldee and an indication of a route for the yieldee from a starting location to a destination location. Then when the smart contract is deployed to the distributed ledger network, vehicles may accept the yield request by transmitting location information to the smart contract indicating that the vehicles are travelling along the route for the yieldee and are currently ahead of the yieldee on the route. Vehicles which prove that they are travelling along the route for the yieldee and are currently ahead of the yieldee on the route via the location information may complete the yield request and receive a reward.

Subsequent data sent to the smart contract may include a message signed by private keys corresponding to the public keys identifying the yieldee in the smart contract or private keys corresponding to the public keys identifying the yielder in the smart contract, thus providing cryptographic proof that the transaction was originated by an authorized yielder and/or an authorized yielder. The private and public keys may be managed solely by the yieldee/yielder to minimize the attack surface for any attackers that might attempt to forge a transaction (e.g., the yieldee/yielders generate public/private cryptographic key pairs offline, and only provide the public key to other network participants). A yieldee/yielder's private keys may be generated according to a securely stored seed value (e.g., on a piece of physical paper or multiple copies of a piece of paper) such that the private keys may be recovered in the case of a data loss.

To determine that the yield request has been completed and provide the reward to the yielder, the yield request smart contract state 606 may obtain evidence of the yield request. The evidence for the yield request may include evidence that the yield request has been accepted and/or evidence that the yield request has been completed. The evidence that the yield request has been accepted may include an indication from the yielder accepting the yield request. The evidence that the yield request has been completed may include an indication from the yieldee that the yield request has been completed. Additionally or alternatively, the evidence that the yield request has been completed may include location information or other sensor data from the yielder and/or the yieldee. For example, when the location information shows that the yielder changed lanes, the smart contract may determine that the yield request has been completed. In another example, the smart contract may determine that the yield request has been completed when the location information shows that the yieldee has passed or merged in front of the yielder on the route. Upon deploying the smart contract and upon accepting the yield request, the yieldee and the yielder may periodically or continuously transmit location information to the smart contract.

The yieldee and/or the yielder may broadcast transactions to the blockchain 602 that includes the evidence. The evidence may be cryptographically signed to provide cryptographic proof-of-identity that the evidence came from the yieldee or a yielder authorized to complete a yield request. Accordingly, the smart contract may compare the provided identity to a list of yielders authorized to complete yield requests.

Another aspect of the yield request smart contract state 606 is the smart contract data. Smart contract data may be thought of like the private and public data in an object created according to an object-oriented programming paradigm in that the smart contract data may be directly updated from outside the object, or the smart contract data may be updated only in limited ways, such as by calling a method of the smart contract. The smart contract data may include a description of the yield request including the type of yield request. The smart contract data for the yield request may also include the reward type and/or reward amount for the yield request. In some scenarios, the reward type may be a cryptocurrency or other digital/virtual currency. The yieldee may provide the amount of the cryptocurrency or other digital/virtual currency specified by the reward amount to the smart contract address on the distributed ledger network which may be released to the yielder when the smart contract determines that the yield request has been completed. In other scenarios, the reward type may be a fiat currency, rewards points, or any other suitable type of reward. The yieldee may not provide these reward types to the smart contract, but the smart contract may cause a trusted, secure, and immutable record of the reward owed to the yielder to be recorded in the distributed ledger. Then the yieldee may provide the reward to the yielder outside of the distributed ledger environment. Additionally, the smart contract data for the yield request may include an indication as to whether the request has been accepted, and/or an indication as to whether the request has been completed.

For example, as illustrated in FIG. 6, the smart contract data may include a yield request to let the yieldee pass or merge in front of the yielder on Main Street for $0.50, an indication that the request has been accepted by the yielder, and an indication that the requested has been completed. Accordingly, the smart contract may provide the reward to the yielder, for example when the reward is a digital token or cryptocurrency that has been transmitted to the smart contract. Alternatively, the smart contract may record that the yieldee owes the yielder the reward, which may be provided from the yieldee to the yielder outside of the distributed ledger network.

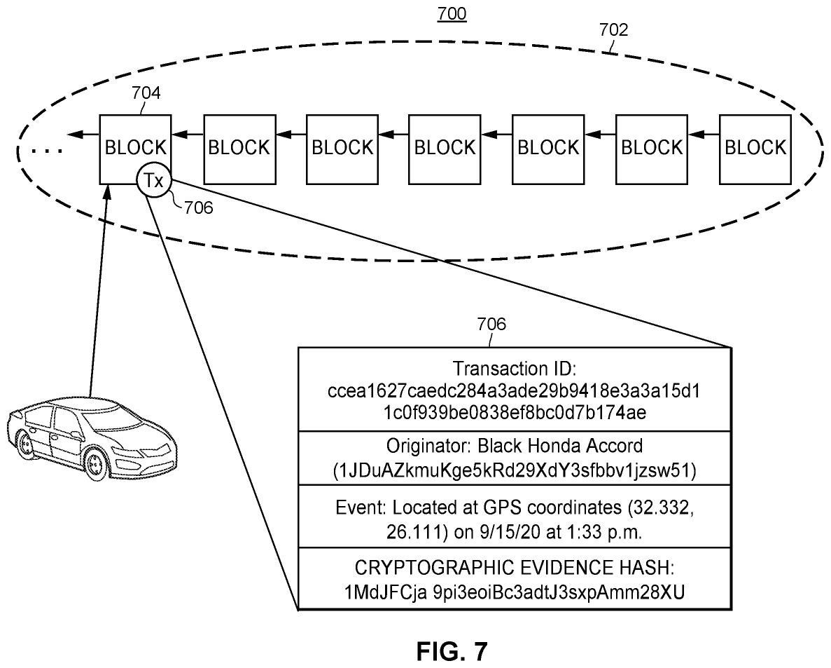

As described above, the yieldee and/or the yielder may broadcast transactions to the blockchain 602 that includes the evidence. In some scenarios, the transactions are provided to the yield request smart contract to alter the smart contract state, for example. FIG. 7 depicts an exemplary transaction 706 representing an evidence transaction indicating the location of the yielder to provide evidence that the request has been completed. The transaction 706 may be generated by the yielder vehicle 112 and/or client device 104 acting as an evidence oracle. The yielder vehicle 112 and/or client device 104 broadcasts a transaction 706 to blockchain 702 to be included in a block, such as block 704.

The transaction 706 may include a transaction ID and an originator such as a yielder vehicle 112 which may be a Black Honda Accord (identified by a cryptographic proof-of-identity). The transaction 706 may also include location information for the yielder vehicle 112 and a timestamp for the location information to establish that the yield request has been completed by the yielder vehicle 112. Furthermore, the transaction 706 may include a cryptographic hash of the location information. In another implementation, the location information is not stored as a cryptographic hash, but is directly accessible in block 704 by an observer or other network participant.

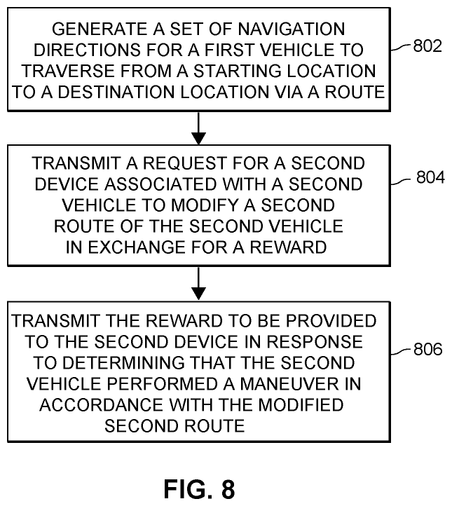

FIG. 8 illustrates an example method 800 for modifying a route based on a user's schedule, which can be implemented at a client device 102 within a first vehicle 110 or a vehicle head unit 114 within the first vehicle 110, for example. The client device 102 or the vehicle head unit 114 within the first vehicle 110 may be referred to herein as a “first device.” The method can be implemented in a set of instructions stored on a computer-readable memory and executable at one or more processors of the client device 102 or the vehicle head unit 114. For example, the method can be implemented by the navigation application.

At block 802, a set of navigation directions are generated for the first vehicle 110 to traverse a route from a starting location to a destination location. The set of navigation directions may be generated by transmitting a request to a traffic flow server 160 and/or a navigation server 162 for navigation directions from the starting location to the destination location. The traffic flow server 160 and/or the navigation server 162 may then transmit the set of navigation directions to the first device in response to the request along with an indication of the estimated duration and/or estimated time of arrival for arriving at the destination location.

At block 804, the first device transmits a request for a second device associated with a second vehicle 112 to modify a second route of the second vehicle 112 in exchange for a reward. The second device may be a second client device 104 communicatively coupled to the second vehicle 112 or a second vehicle head unit 114 within the second vehicle 112. The modified route may reduce an amount of time for the first vehicle 110 to traverse the first route to the destination location. More specifically, the request may be a yield request, and the modified route may include a lane change, pulling over, slowing down, or beginning the second route at a later or earlier time than originally scheduled. By yielding to the first vehicle 110, the first vehicle 110 may arrive at the destination location earlier.

In some implementations, the first device transmits the request via a navigation application executing on the first device and selects the second vehicle 112 via user controls at the navigation application. In other implementations, the second vehicle 112 is automatically selected for example, by a V2V communication with the second vehicle 112 or by obtaining a set of vehicles ahead of the first vehicle 110 on the first route from the traffic flow server 160. In yet other implementations, the first device broadcasts the request to each of the vehicles ahead of the first vehicle 110 on the first route, for example via a V2V communication.

In response to the request, the first device may receive an indication that the second vehicle 112 accepts the request. The first device then provides the reward to be provided to the second device in response to determining that the second vehicle 112 performs a maneuver in accordance with the modified second route (block 806).

For example, the first device may provide the reward to the traffic flow server 160 which may hold the reward in escrow. The traffic flow server 160 may then provide the reward to the second device in response to determining that the second vehicle 112 completed the request by performing a maneuver in accordance with the modified second route. The traffic flow server 160 may determine that the second vehicle 112 completed the request by receiving an indication from the first device that the second vehicle 112 completed the request, by receiving location information from the first device and/or the second device which may indicate that the first vehicle 110 passed or merged in front of the second vehicle 112, or by obtaining any other suitable information indicating that the yield request has been completed.

In another example, the first device may generate and deploy a smart contract for determining whether the second vehicle 112 completed the request and for providing the reward to the second device in response to determining that the second vehicle 112 completed the request. The first device may transmit the reward to the smart contract address for the smart contract, and the smart contract may transmit the reward to the second device upon determining that the second vehicle 112 completed the request. The smart contract may determine that the second vehicle 112 completed the request by receiving an indication from the first device that the second vehicle 112 completed the request, by receiving location information from the first device and/or the second device which may indicate that the first vehicle 110 passed or merged in front of the second vehicle 112, or by obtaining any other suitable information indicating that the yield request has been completed.

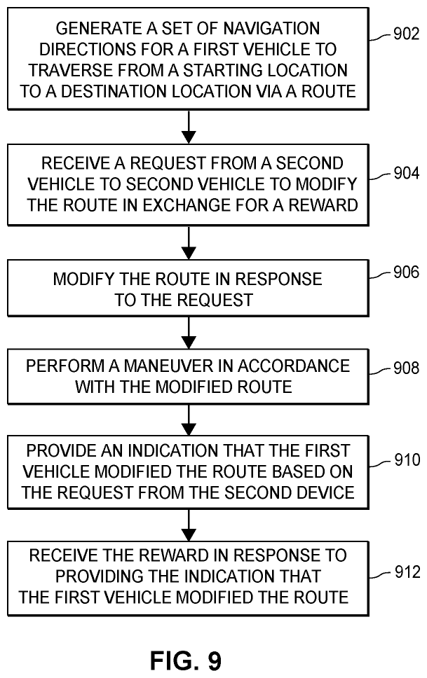

FIG. 9 illustrates an example method 900 for modifying a route based on a user's schedule, which can be implemented at a client device 102 within a first vehicle 110 or a vehicle head unit 114 within the first vehicle 110, for example. The client device 102 or the vehicle head unit 114 within the first vehicle 110 may be referred to herein as a “first device.” The method can be implemented in a set of instructions stored on a computer-readable memory and executable at one or more processors of the client device 102 or the vehicle head unit 114. For example, the method can be implemented by the navigation application

At block 902, a set of navigation directions are generated for the first vehicle 110 to traverse a first route from a starting location to a destination location. The set of navigation directions may be generated by transmitting a request to a traffic flow server 160 and/or a navigation server 162 for navigation directions from the starting location to the destination location. The traffic flow server 160 and/or the navigation server 162 may then transmit the set of navigation directions to the first device in response to the request along with an indication of the estimated duration and/or estimated time of arrival for arriving at the destination location.

At block 904, the first device receives a request from a second device associated with a second vehicle 112 to modify the first route in exchange for a reward. The second device may be a second client device 104 communicatively coupled to the second vehicle 112 or a second vehicle head unit 114 within the second vehicle 112. The modified first route may reduce an amount of time for the second vehicle 112 to traverse a second route to a second destination location. More specifically, the request may be a yield request, and the modified first route may include a lane change, pulling over, slowing down, or beginning the first route at a later or earlier time than originally scheduled. By yielding to the second vehicle 112, the second vehicle 112 may arrive at the second destination location earlier.

In some implementations, the first device receives the request via a navigation application executing on the first device from a traffic flow server 160 or directly from the second device via a V2V communication, for example. In response to receiving the request, the first device may transmit an indication accepting the request to the traffic flow server 160 or directly to the second device. The first device then modifies the first route in response to the request (block 906). For example, the navigation application may modify the set of navigation directions based on the modified first route which includes a lane change, pulling over, slowing down, or beginning the first route at a later or earlier time than originally scheduled.

Then at block 908, a maneuver is performed in accordance with the modified first route. The maneuver may be performed automatically for example, when the first vehicle 110 is an autonomous vehicle. In this scenario, the navigation application may transmit control signals to the first vehicle 110 to cause the first vehicle 110 to maneuver in accordance with the modified first route. In other scenarios, the maneuver may be performed manually by a person operating the first vehicle 110. In any event, in response to performing the maneuver in accordance with the modified first route, the first device provides an indication that the first vehicle completed the request by performing a maneuver in accordance with the modified first route (block 910). For example, the first device may transmit the indication to the traffic flow server 160 which may provide the reward to the first device in response to determining that the first vehicle completed the request (block 912). In another example, the first device may transmit the indication to a smart contract which may provide the reward to the first device in response to determining that the first vehicle completed the request. The indication that the first vehicle completed the request may include location information from the first device which may indicate that the second vehicle 112 passed or merged in front of the first vehicle 110, or any other suitable information indicating that the yield request has been completed.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for modifying routes based on users' schedules through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for modifying a route based on a user's schedule, the method comprising:
generating, by one or more processors at a first device associated with a first vehicle, a set of navigation directions for traversing from a starting location to a destination location via a route;
receiving, at the one or more processors, a request to modify the route, the request related to a second device associated with a second vehicle;
modifying, by the one or more processors, the route in response to the request; and
in response to performing a maneuver in accordance with the modified route, providing, by the one or more processors, an indication that the first vehicle modified the route based on the request from the second device.

2. The method of claim 1, wherein providing an indication that the first vehicle modified the route based on the request from the second device includes:
providing, by the one or more processors to a server device, an indication of a current location of the first vehicle relative to a current location of the second vehicle.

3. The method of claim 1, wherein the request to modify the route is provided in exchange for a reward, and further comprising:
receiving, at the one or more processors, the reward in response to providing the indication that that the first vehicle modified the route.

4. The method of claim 1, wherein receiving a request to modify the route includes:
receiving, at the one or more processors, a request for the first vehicle to yield to the second vehicle.

5. The method of claim 4, wherein receiving a request for the first vehicle to yield to the second vehicle includes:
receiving, at the one or more processors, a request for the first vehicle to maneuver into another lane from a lane occupied by the second vehicle.

6. The method of claim 1, wherein receiving a request to modify the route includes:
receiving, at the one or more processors, a request for the first vehicle to begin the route at a later time after the second vehicle passes a location of the first vehicle.

7. The method of claim 1, further comprising:
providing, by the one or more processors, an indication of a deadline for arriving at the destination location; and
receiving, at the one or more processors, the request to modify the route when the deadline is more than a threshold amount of time after an estimated time period for navigating from the starting location to the destination location.

8. A method for modifying a route based on a user's schedule, the method comprising:
generating, by one or more processors at a first device associated with a first vehicle, a set of navigation directions for traversing from a starting location to a destination location via a first route;
transmitting, at the one or more processors, a request for a second device associated with a second vehicle to modify a second route of the second vehicle in exchange for a reward, wherein the modified second route of the second vehicle reduces an amount of time for the first vehicle to traverse the first route to the destination location; and
providing, by the one or more processors, the reward to be provided to the second device in response to determining that the second vehicle performed a maneuver in accordance with the modified second route.

9. The method of claim 8, wherein transmitting a request for a second device associated with a second vehicle to modify a second route of the second vehicle in exchange for a reward includes:
detecting, by the one or more processors, identification information for the second vehicle via a camera or short-range communication link;
providing, by the one or more processors, the identification information for the second vehicle to a server device for the server device to request the second device associated with the second vehicle to modify the second route.

10. The method of claim 9, wherein detecting identification information for the second vehicle includes at least one of:
detecting a license plate number for the second vehicle,
detecting an identifier placed on the second vehicle, or
receiving a message via the short-range communication link from the second device associated with the second vehicle including the identification information for the second vehicle.

11. The method of claim 8, wherein transmitting a request for a second device associated with a second vehicle to modify a second route of the second vehicle in exchange for a reward includes:
broadcasting, by the one or more processors, the request to vehicles within a communication range of the first vehicle, wherein the request includes an indication of the reward; and
receiving, by the one or more processors, a response message from the second device associated with the second vehicle indicating that the second vehicle accepts the request.

12. The method of claim 8, wherein transmitting a request for a second device associated with a second vehicle to modify a second route of the second vehicle in exchange for a reward includes:
transmitting, by the one or more processors to a server device, a request for vehicles in front of the first vehicle to modify respective routes in exchange for the reward, wherein the server device identifies vehicles in front of the first vehicle and forwards the request to the identified vehicles.

13. The method of claim 8, further comprising:
determining, by the one or more processors, an estimated time of arrival at the destination location based on a starting time for the first route; and
obtaining, by the one or more processors, a requested arrival time at the destination location from a user,
wherein the request for the second device to modify the second route is transmitted in response to determining that the estimated time of arrival is after the requested arrival time at the destination location.

14. The method of claim 8, wherein determining that the second vehicle performed a maneuver in accordance with the modified second route includes at least one of:
passing the second vehicle by the first vehicle,
merging with the second vehicle by the first vehicle, or
receiving an indication of a current location of the second vehicle.

15. The method of claim 8, wherein providing the reward includes:
providing, by the one or more processors, the reward to a server device prior to the second vehicle performing the maneuver in accordance with the modified second route, wherein the server device determines that the second vehicle performed the maneuver in accordance with the modified second route and provides the reward to the second vehicle in response to the determination.

16. A method for creating a smart contract for rewarding vehicles to modify routes using a distributed ledger maintained by a plurality of participants, the method comprising:
generating, by one or more processors, a smart contract that provides a reward from a first vehicle to a second vehicle in response to the second vehicle modifying a route in a manner that benefits the first vehicle; and
deploying, by the one or more processors, the smart contract to an address stored on the distributed ledger maintained by the plurality of participants in a distributed ledger network,
wherein in response to receiving an indication that the second vehicle performed a maneuver in accordance with the modified route, the smart contract provides the reward to a device associated with the second vehicle.

17. The method of claim 16, wherein the smart contract includes a current location of the first vehicle and an indication of a first route for the first vehicle from a starting location to a destination location, and wherein the smart contract includes an offer for vehicles travelling along the route which are currently ahead of the first vehicle on the route to modify respective routes to receive the reward.

18. The method of claim 17, wherein the smart contract obtains the reward from a device associated with the first vehicle, and obtains an indication from the device associated with the second vehicle that the second vehicle accepts the offer to modify the route in exchange for the reward.

19. The method of claim 17, further comprising:
determining, by the one or more processors, an estimated time of arrival at the destination location based on a starting time for the first route; and
obtaining, by the one or more processors, a requested arrival time at the destination location from a user,
wherein the smart contract is generated in response to determining that the estimated time of arrival is after the requested arrival time at the destination location.

20. The method of claim 15, further comprising:
in response to determining that the second vehicle performed the maneuver in accordance with the modified route, generating, by the one or more processors, a transaction indicating that the second vehicle performed the maneuver in accordance with the modified route; and
transmitting the transaction to the smart contract stored on the distributed ledger maintained by the plurality of participants in a distributed ledger network.
